(19) United States
(12) Patent Application Publication
(10) Pub. No.: US 2010/0021594 A1
(43) Pub. Date: Jan. 28, 2010

(54) METHOD OF MICROWAVE COOKING OF RAW MEAT AND RAW MARINE PRODUCT, SEASONING FOR MICROWAVE COOKING, AND FOOD FOR MICROWAVE COOKING

(76) Inventor: Hiromichi Minakawa, Ibaraki (JP)

Correspondence Address: CERMAK KENEALY VAIDYA & NAKAJIMA LLP, 515 EAST BRADDOCK RD SUITE B, Alexandria, VA, 22314, US

(21) Appl. No.: 12/575,047

(22) Filed: Oct. 7, 2009

Related U.S. Application Data
(63) Continuation of application No. 10/529,477, filed on Mar. 28, 2005.

(30) Foreign Application Priority Data
Oct. 17, 2002 (JP) 2002-338599

(51) Int. Cl. A23L 1/01; A23P 1/08; A23L 1/31; A23L 1/325

(52) U.S. Cl. 426/234; 426/243

(57) ABSTRACT

Provided are a method of microwave cooking of raw meat or raw marine products in which an unpleasant fishy odor is prevented from occurring during microwave cooking, a seasoning for microwave cooking, and a food for microwave cooking. A food containing at least an organic acid is used as a seasoning for microwave cooking. A food for microwave cooking is prepared by seasoning raw meat or a raw marine product so that the seasoning for microwave cooking is fixed on the surface of the raw meat or the raw marine product. The food for microwave cooking is microwave-heated.

This application is a continuation under 35 U.S.C.§120 of U.S. patent application Ser. No. 10/529,477, filed on Mar. 28, 2005, which was a national stage filing under 35 U.S.C.§371 of PCT Patent Application No. PCT/JP03/11257, filed on Sep. 3, 2003, which claimed priority under 35 U.S.C.§119 to Japanese Patent Application No. 2002-338599, filed on Oct. 17, 2002, all of which are incorporated by reference in their entireties.

### BACKGROUND OF THE INVENTION

1. Technical Field

The present invention relates to microwave cooking methods in which raw meat and raw marine products are cooked using only a microwave oven, seasonings for microwave cooking, and foods for microwave cooking. More particularly, the present invention relates to a method of microwave cooking of raw meat or raw marine products, in which a fishy odor is prevented from occurring when cooking with a microwave oven, and browning can be achieved that is substantially the same as that obtained by grilling; a seasoning for microwave cooking; and a food for microwave cooking.

2. Background Art

Recently, demands for foods that can be cooked with a microwave oven (hereinafter referred to as “foods for microwave cooking”) have greatly increased because the foods can be cooked easily so as to be edible by heating with a microwave oven without using an open fire and without staining the kitchen, and also because a desired amount of food can be easily cooked, even if only a small amount is required, such as one serving.

However, if raw meat or raw marine products are directly cooked in a microwave oven, an unpleasant fishy odor occurs at the beginning of heating. Furthermore, grilling that can achieve browning cannot be performed using a microwave oven. Consequently, in the case of raw meat and raw marine products, as the food for microwave cooking, only products which have been grilled and which are then to be warmed up in a microwave oven, i.e., which do not require cooking, but to be simply heated, are available. An unpleasant fishy odor is not generated even if such a grilled product is microwave-heated. However, if the grilled product is warmed up in a microwave oven, water seeps out to the surface of the product after heating as if steaming were performed after grilling, which is far from being satisfactory.

Recently, various methods for microwave cooking in which browning that is substantially the same as that obtained by grilling can be achieved have been proposed. For example, in a first method, a microwave heating layer is provided on a surface of a film or sheet substrate, the microwave heating layer being formed of a thin metal film or by vapor deposition of a mixture of a metal and a metal oxide, and by enwrapping a food product itself in the substrate, heat is generated on the surface of the substrate during microwave heating so that the surface of the food becomes browned (refer to Japanese Unexamined Patent Application Publication No. 10-117941).

In a second method, a food product itself is wrapped with a sheet that has been impregnated or coated with an edible fat and oil, and the temperature of the surface of the food is increased due to the edible fat and oil during microwave heating so that the surface of the food becomes browned (refer to Japanese Unexamined Patent Application Publication No. 2000-142829).

In a third method, a browning composition containing a caramel coloring agent and a thickening agent is applied to the surface of a food product (dough crust), and a browning reaction is carried out by microwaves generated during microwave heating (refer to Japanese Unexamined Patent Application Publication No. 9-107867).

In the first method, food products having a low water content, such as pies, bread, and pizzas, can be browned. However, with respect to food products having a high water content, since an excessive amount of water adheres to the surface of the substrate, the temperature does not easily increase during heating, and as a result, browning cannot be achieved. Moreover, when raw meat or raw fish is cooked, it is not possible to eliminate a fishy odor at the beginning of heating. Furthermore, in the second method or the third method, although the surface of the food can be browned, when raw meat or raw fish is cooked, it is also not possible to eliminate a fishy odor at the beginning of heating. Furthermore, with respect to known seasonings, in the case a food having a three-dimensional shape, the seasonings flow from the surface of the food during heating, and the effect thereof is not obtained sufficiently.

The present invention has been achieved to overcome the problems described above. It is an object of the present invention to provide a method of microwave cooking of raw meat or raw marine products in which browning can be achieved by microwave cooking, and no unpleasant fishy odor occurs during cooking; a seasoning for microwave cooking; and a food for microwave cooking.

### SUMMARY OF THE INVENTION

In order to achieve the object described above, in accordance with the present invention, an unpleasant fishy odor component generated during microwave cooking of raw meat or raw marine products can be prevented by a chemical deodorization method in which by preliminarily seasoning the raw meat or the raw marine products with a seasoning containing a specific first component, the unpleasant fishy odor is changed to a non-odorous component by a chemical reaction by a natural component or a chemical component contained in the seasoning. Furthermore, in accordance with the present invention, by preliminarily seasoning raw meat or raw marine products with a seasoning containing a specific first component and a second component, any unpleasant fishy odor generated during microwave cooking of the raw meat or the raw marine products can be eliminated and browning that is substantially the same as that obtained by grilling can be achieved on the surface of the raw meat or the raw marine products.

That is, as described in claim 1, a first method of microwave cooking of raw meat or raw marine products according to the present invention includes seasoning the raw meat or the raw marine products so that a seasoning containing at least an organic acid is fixed on the surface of the raw meat or the raw marine products, and then performing microwave heating so that any fishy odor generated during cooking can be eliminated.

In this method, the organic acid as the first component contained in the seasoning neutralizes and decomposes the unpleasant fishy odor of the raw meat or the raw marine products into a non-odorous component, and any fishy odor generated during microwave cooking is eliminated so that cooking can be satisfactorily performed. Moreover, since the seasoning containing the organic acid is applied so as to be fixed on the surface of the raw meat or the raw marine products, a fishy odor of the raw meat or the raw marine products, in particular, a fishy odor on the skin of raw fish, can be effectively eliminated.

Furthermore, in a second method of microwave cooking according to the present invention, as described in claim 2, in addition to the method of microwave cooking described above, a starch, a thermosetting protein, and an edible fat and oil are added to the organic acid in order to fix the seasoning on the surface of the raw meat or the raw marine products.

In this method, the starch increases its viscosity during heating to improve the adhesion of the seasoning to the surface of the food, and thus the seasoning is prevented from flowing from the surface of the food. Furthermore, the thermosetting protein is hardened during heating thus strengthening the adherence of the seasoning to the surface of the food, and the seasoning is further prevented from flowing from the surface of the food. Moreover, the edible fat and oil further increase the temperature of the surface of the microwave-heated food and also provide a separating action which prevents the food from sticking to cooking equipment or the like due to the hardening of the starch and the protein. The edible fat and oil also control the viscosity so that the organic acid, the starch, and the thermosetting protein are uniformly mixed in the seasoning and the seasoning is applied over the entire surface of the food.

Consequently, even if the raw meat or the raw marine product as the food has an uneven and rounded surface, i.e., has a three-dimensional surface, the seasoning can still easily adhere to the entire surface. Moreover, if the seasoning is heated, although the seasoning adheres to the surface of the food due to the adhesiveness of the starch at the beginning, the hardening process of the protein then causes, from about 70.degree. C., a state in which dissolution does not easily take place. As a result, even if water vapor is generated by heating, dissolution is not caused and the seasoning remains on the surface of the food. The seasoning is not removed from the surface of the food due to dissolution or softening. Therefore, any fishy odor from the raw meat or the raw marine products generated during cooking, in particular, a fishy odor on the skin of raw fish, can be stably and effectively eliminated by the organic acid. Furthermore, the food can be easily removed from the cooking equipment or the like after heating.

Furthermore, in a third method of microwave cooking according to the present invention, as described in claim 3, in addition to either one of the methods of microwave cooking described above, the seasoning further contains a melanoidin or a melanoidin-producing material as the second component.

In this method, simultaneously with the elimination of a fishy odor of the raw meat or the raw marine products generated during cooking, when the melanoidin or the melanoidin-producing material contained in the seasoning is heated at a surface temperature of about 120.degree. C. to 200.degree. C. for a short period of time, i.e., for one to two minutes, as the surface temperature of the food is increased by microwave heating, the Maillard reaction is promoted so as to brown the surface of the food. Thereby, grilling can be performed in which spicy browning that is substantially the same as that obtained by grilling with an oven or the like can be achieved on the surface of the food.

Each of the first and second methods of microwave cooking according to the present invention can be achieved using the seasoning for microwave cooking described below. That is, as described in claim 4, a first seasoning for microwave cooking according to the present invention comprises an organic acid-containing food, a starch, a thermosetting protein, and an edible fat and oil.

Furthermore, each of the first and second methods of microwave cooking of the present invention can be achieved using the seasoning for microwave cooking described below. That is, as described in claim 5, a second seasoning for microwave cooking according to the present invention comprises an organic acid-containing food, a starch, a thermosetting protein, an edible fat and oil, and a melanoidin or a melanoidin-producing material.

As a third seasoning for microwave cooking according to the present invention, as described in claim 6, the organic acid-containing food included in the first or second seasoning for microwave cooking is preferably a fermented food.

Examples of the organic acid which neutralizes and decomposes the unpleasant fishy odor, generated during cooking, of the raw meat or the raw marine products include acetic acid, citric acid, succinic acid, malic acid, lactic acid, butyric acid, and tartaric acid. Examples of the food containing such an organic acid (seasoning) include citrus fruits, such as lemon, lime, yuzu (citrus junos), sudachi (citrus sudachi), and kabosu (citrus sphaerocarpa), and fermented foods, such as soy sauce, miso, ketchup, sauce, mirin (sweet rice wine for cooking), vinegar, alcoholic beverages made by fermentation, yogurt, and cheese.

Examples of soy sauce and miso include those produced by fermentation using rice, wheat, beans, fish, shrimp, etc., as raw materials, such as dark soy sauce, light soy sauce, white soy sauce, tamari soy sauce, saishikomi (twice-brewed) soy sauce, rice miso, barley miso, and soybean miso; and Chinese “jiang” prepared using rice, glutinous rice, wheat, barley, soybeans, broad beans, fish, shrimp, etc., as the main raw materials and condiments, such as red pepper, as auxiliary raw materials. Examples of vinegar include grain vinegar, rice vinegar, barley vinegar, black vinegar, and wine vinegar. Examples of the alcoholic beverages made by fermentation include “fermented alcoholic beverages”, such as Japanese sake, wine, shokoshu (Chinese rice wine), and beer, but do not include “distilled alcoholic beverages” which are produced by distilling fermented alcoholic beverages.

As the starch and the thermosetting protein, preferably, mixtures of these, such as grains and tubers, are used. Desirably, a mixture containing 3% by weight or more of a protein component is used. Preferred examples of the starch-protein mixture include powdered grains, such as rice, wheat, barley, rye, oat, hatomugi (coix), foxtail millet, hie (Japanese barnyard millet), millet, buckwheat, and corn. When tubers having a low protein content, such as potato, sweet potato, aroid, konnyaku potato, yam, cassava, and taro, are used, the protein content is adjusted by adding thermosetting proteins, such as soy protein, wheat protein, lactoprotein, egg white, egg yolk, eggs, meat, and seafood.

Preferred examples of the edible fat and oil include edible oils that are in a liquid state at ordinary temperatures, such as salad oil, olive oil, rapeseed oil, soybean oil, corn oil, safflower oil, cottonseed oil, sesame oil, peanut oil, safflower oil, sunflower oil, linseed oil, jojoba oil, grapeseed oil, and squalane; and edible fats that are solid at ordinary temperatures, such as milk fat, coconut oil, palm oil, beef tallow, lard, cacao butter, shortening, and margarine. Although depending on the food to be microwave-cooked, when the food itself contains 15% or more of an oil component, the oil content in the seasoning is preferably set at 50% to 70% by mass, and when the food itself contains only less than 15% of an oil component, the oil content in the seasoning is preferably set at 60% to 95% by mass.

Namely, in a food containing 15% or more of the oil component, the temperature is quickly increased by microwave heating, and the oil component seeps out of the food during heating. Therefore, even if the oil content in the seasoning is 50% to 70% by mass, the surface temperature of the food can be sufficiently increased to 140.degree. C. to 160.degree. C. For example, in the case of a fillet of raw mackerel, salted mackerel, or the like containing 26.8% in terms of the oil component, even if the oil content in the seasoning is 50% by mass, the temperature of the surface of the food can be sufficiently increased. Consequently, no fishy odor occurs during heating, and a spicy and desirable aroma is present even after heating is completed. In the case of a fillet of candlefish, Patagonian toothfish, or the like which has been processed without using soy sauce, if the oil content in the seasoning is 70% by mass, the temperature of the surface of the food can be increased. After cooking, it does not appear as if the food were steamed. No unpleasant fishy odor is generated during heating, and furthermore, no unpleasant fishy odor remains after heating.

However, if the oil content in the seasoning is 50% by mass or less, the temperature on some areas of the surface of the food may not be increased to 140.degree. C., and it may appear as if the food were partially steamed. If the oil content in the seasoning is 70% by mass or more, in the case of a processed food which has been marinated in mirin (sweet rice wine for cooking) and soy sauce, dark brown deposits may occur. Additionally, in the case of a food product which has been processed using soy sauce, if the oil content in the seasoning is about 50% to 60% by mass, the temperature of the surface of the food can be increased, and the food can be cooked without being excessively browned so as to acquire a spicy and desirable aroma.

On the other hand, with respect to a food containing only less than 15% of an oil component, an increase in temperature by microwave heating is slow. Furthermore, water is released during heating, and it takes time to evaporate the water. Therefore, unless the oil content in the seasoning is set at 60% to 95% by mass, it is not possible to increase the temperature of the surface of the food sufficiently. This range of the oil content is wide because the oil content in the food also influences cooking and contributes to an increase in temperature during cooking. For example, in the case of a fillet of Spanish mackerel with an oil content of 9.7%, if the oil content in the seasoning is about 60% by mass, the temperature of the surface of the food can be sufficiently increased, and no unpleasant fishy odor is generated during heating. In the case of a fillet of salmon or the like with an oil content of 12%, the skin portion has a fishy odor if cooked as it is. However, if the oil content in the seasoning is set at about 60% to 70% by mass, the temperature of the surface of the food can be increased to 140.degree. C., and cooking can be performed without producing an unpleasant fishy odor. In the case of a fillet of salted cod or the like with a high content of water, if the oil content in the seasoning is set at about 80% to 95% by mass, the temperature of the surface of the food can be sufficiently increased during heating, and finishing can be performed, without an unpleasant fishy odor, as if the food were grilled. The reason for this is that by increasing the temperature of the surface of the food, the fishy odor is decomposed, exuded, and adsorbed by the organic acid in the seasoning, and thus cooking can be performed satisfactorily.

Furthermore, as the melanoidin, melanoidin-containing foods are used, and as the melanoidin-producing material, foods containing amino acids and saccharides are used. Examples of the melanoidin-containing foods to be used include fermented foods, such as soy sauce, miso, uobishio (fermented food made from salted fish), shishibishio (fermented food made from salted animal meat), beer, oyster sauce, tobanjang (Chinese red pepper paste), and kochujang (Korean red pepper paste). Examples of amino acids include glycine, alanine, serine, leucine, glutamic acid, aspartic acid, histidine, and lysine. Examples of saccharides include sugar, fructose, glucose, maltose, xylitol, arabinose, honey, and maple syrup. Examples of the melanoidin-producing materials, i.e., foods containing amino acids and saccharides, include Worcester sauce, chuno sauce, tonkatsu sauce, and okonomiyaki sauce.

In the present invention, according to taste, each of the seasonings for microwave cooking described above may be incorporated with a condiment, such as pepper, mustard, wasabi (Japanese horseradish), ginger, sansho (Japanese pepper), red pepper, thyme, rosemary, cloves, coriander, or fennel.

Furthermore, the present invention provides a food for microwave cooking which is prepared by seasoning raw meat or a raw marine product so that any one of the first to third seasonings for microwave cooking is fixed on the surface of the raw meat or the raw marine product. The food for microwave cooking may be frozen after being seasoned, and the food in a frozen state can be cooked in a microwave oven. Additionally, the food for microwave cooking is preferably refrigerated for 2 to 3 hours after the seasoning for microwave cooking is applied to the food from the standpoint that any fishy odor can be removed more effectively.

### DETAILED DESCRIPTION OF EXEMPLARY EMBODIMENTS

Examples of the present invention will be described below.

### Example 1

In Example 1, first, as ingredients for a seasoning for microwave cooking, 100 g of soy sauce as an organic acid-containing fermented food, 10 g of wheat as a starch-thermosetting protein mixture, 100 g of hydrogenated soybean oil as an edible fat, and 30 g of salad oil as an edible oil were prepared. Subsequently, all of the wheat was added to the soy sauce, and the resulting mixture was gelated by heating. Hydrogenated soybean and salad oil were added to the resulting gel, followed by stirring, and thus a seasoning for microwave cooking in the form of a paste was produced. The seasoning for microwave cooking was applied and allowed to adhere over the entire surface of a 60 g fillet of mackerel as a food to produce a food for microwave cooking. The food for microwave cooking was placed in a container and heated at 500 W in a microwave oven for 3 minutes.

As a result, the food for cooking was cooked uniformly and satisfactorily. Furthermore, during the cooking of the food for microwave cooking, the seasoning did not flow from the surface of the food due to a decrease in the viscosity of the seasoning, no unpleasant fishy odor occurred, and only a desirable aroma of mackerel being browned was noted. The surface of the food turned brown during the cooking process as if the food were grilled in an oven. Moreover, the skin portion was also uniformly browned with a spicy aroma. Water evaporated from the food was adequately discharged, and a wet feeling, such as that obtained when the food was steamed, did not remain on the surface of the food.

### Example 2

In Example 2, as ingredients for a seasoning for microwave cooking, 100 g of soy sauce and 5 g of vinegar as organic acid-containing fermented foods, 7 g of starch, 0.6 g of gluten as a mixture of thermosetting proteins, 150 g of shortening as an edible fat, 130 g of rapeseed oil as an edible oil, and 1 g of ginger as a condiment were prepared. Subsequently, vinegar, starch, gluten, and ginger were added to the soy sauce, and the resulting mixture was gelated by heating. Shortening and rapeseed oil were added to the resulting gel, followed by stirring, and thus a seasoning for microwave cooking in the form of a paste was produced. The seasoning for microwave cooking was applied and allowed to adhere over the entire surface of a 60 g fillet of candlefish to produce a food for microwave cooking. The food for microwave cooking was enwrapped in a sheet and heated at 500 W in a microwave oven for 3 minutes.

As a result, the food for cooking was cooked uniformly and satisfactorily. Furthermore, during the cooking of the food for microwave cooking, no unpleasant fishy odor occurred, and only a desirable aroma of the fish being browned was noted. The surface of the food turned brown during the cooking process as if the food were grilled in an oven. Moreover, water evaporated from the food was adequately discharged, and a wet feeling, such as that obtained when the food was steamed, did not remain on the surface of the food.

### Example 3

In Example 3, as ingredients for a seasoning for microwave cooking, 100 g of miso and 8 g of vinegar as organic acid-containing fermented foods, 5 g of shiratamako (rice flour) as a starch-thermosetting protein mixture, 150 g of shortening as an edible fat, 100 g of salad oil as an edible oil, and 20 g of sugar were prepared. Subsequently, miso, shiratamako, and sugar were mixed under heating to form a stiff gel. Vinegar, shortening, and salad oil were added thereto, followed by stirring, and thus a seasoning for microwave cooking in the form of a paste was produced. A 60 g fillet of Spanish mackerel as a food was marinated in the seasoning for microwave cooking and placed in a refrigerator for 3 hours. Freezing was then performed to produce a food for microwave cooking. The frozen food was placed in a container and heated at 500 W in a microwave oven for 3 minutes.

As a result, the food for cooking was cooked uniformly and satisfactorily. Furthermore, during the cooking of the food for microwave cooking, the seasoning did not flow from the surface of the food due to a decrease in viscosity, no unpleasant fishy odor occurred, and only a desirable aroma of Spanish mackerel being browned was noted. The surface of the food slightly turned brown during the cooking process as if the food were grilled in an oven. Moreover, water evaporated from the food was adequately discharged, and a wet feeling, such as that obtained when the food was steamed, did not remain on the surface of the food.

### Example 4

In Example 4, as ingredients for a seasoning for microwave cooking, 170 g of soy sauce as an organic acid-melanoidin-containing food, 20 g of wheat as a starch-thermosetting protein mixture, 185 g of hydrogenated soybean oil as an edible fat, and 100 g of salad oil as an edible oil were prepared. Subsequently, all of the wheat was added to the soy sauce, and the resulting mixture was gelated by heating. Hydrogenated soybean and salad oil were added to the resulting gel, followed by stirring, and thus a seasoning for microwave cooking in the form of a paste was produced. The seasoning for microwave cooking was applied and allowed to adhere over the entire surface of a 60 g fillet of salmon as a food, and the salmon was enwrapped in a sheet and placed in a bag formed of synthetic resin film. Air was expelled from the bag, and the opening of the bag was sealed by thermal fusion. Freezing was then performed to produce a food for microwave cooking. The bag was partially cut open and the food for microwave cooking in a frozen state was heated at 500 W in a microwave oven for 3 minutes.

As a result, the food for cooking was cooked uniformly and satisfactorily. Furthermore, during the cooking of the food for microwave cooking, the seasoning did not flow from the surface of the food due to a decrease in the viscosity of the seasoning, no unpleasant fishy odor occurred, and only a desirable aroma of salmon being browned was noted. The surface of the food turned brown during the cooking process as if the food were grilled in an oven. Moreover, the skin portion was also uniformly browned with a spicy aroma. Water evaporated from the food was adequately discharged, and a wet feeling, such as that obtained when the food was steamed, did not remain on the surface of the food.

### Example 5

In Example 5, as ingredients for a seasoning for microwave cooking, 10 g of sodium glutamate and 10 g of sucrose as melanoidin-producing materials, 7 g of starch, 0.6 g of gluten as a mixture of thermosetting proteins, 130 g of shortening as an edible fat, 50 g of rapeseed oil as an edible oil, 25 g of water, and 1 g of ginger as a condiment were prepared. Subsequently, sodium glutamate and sucrose were dissolved in water to form a brown melanoidin solution. Starch and gluten were added to the melanoidin solution to form a gel, and shortening and rapeseed oil were added thereto, followed by stirring. Thus, a seasoning for microwave cooking in the form of a paste was produced. As a food, 100 g chicken thigh was marinated in the seasoning for microwave cooking and placed in a refrigerator for 3 hours. The refrigerated food was placed in a container and heated at 500 W in a microwave oven for 10 minutes.

As a result, the food for cooking was cooked uniformly and satisfactorily. Furthermore, during the cooking of the food for microwave cooking, the seasoning did not flow from the surface of the food due to a decrease in viscosity, no unpleasant fishy odor occurred, and only a desirable aroma of chicken skin being browned was noted. The entire surface of the food was sparsely browned by the cooking as if the food were grilled in an oven. Moreover, water evaporated from the food was adequately discharged, and a wet feeling, such as that obtained when the food was steamed, did not remain on the surface.

As described above, in accordance with the present invention, raw meat or raw marine products, in which an unpleasant fishy odor has been produced by conventional methods of microwave cooking, can be cooked without generating an unpleasant odor because the fishy odor is neutralized and decomposed by an organic acid. Moreover, even if the surface of a food is three-dimensional such that the applied seasoning is likely to flow from the surface, by adding a thermosetting protein to the seasoning containing the organic acid, hardening of the thermosetting protein during heating strengthens the adherence of the seasoning to the surface of the food. Therefore, a fishy odor of the raw meat or the raw marine products generated during cooking, in particular, a fishy odor on the skin of raw fish, can be stably and effectively eliminated by the organic acid.

Furthermore, by adding an adequate amount of edible fat and oil to the seasoning, the viscosity is easily controlled so that the organic acid, the starch, and the thermosetting protein are uniformly mixed in the seasoning and the seasoning is applied over the entire surface of the food. The edible fat and oil further increase the temperature of the surface of the microwave-heated food, and also prevent the food from sticking to cooking equipment or the like due to the hardening of the starch and the protein so that the food can be easily removed from the cooking equipment or the like after heating.

What is claimed is:

1. A method for cooking at least one of a raw meat and a raw marine product, comprising:
providing a starch, a protein, an oil component, an organic acid, and a melanoidin;
forming a paste from at least the starch, the protein, the oil component, an organic acid, and the melanoidin including:
combining the starch, the protein, the organic acid and the melanoidin into a mixture;
gelating the mixture including heating the mixture;
combining the oil component to the mixture; and
stirring the combination of the oil component and the mixture;
applying the paste to the entire exterior of the at least one of the raw meat and the raw marine product; and
microwave cooking the at least one of the raw meat and the raw marine product with the paste thereon,
wherein the at least one of the meat and marine product has a grilled browned appearance after the microwave cooking.

2. The method for cooking at least one of a raw meat and a raw marine product according to claim 1, wherein the providing the organic acid includes providing the organic acid selected from the group consisting of acetic acid, citric acid, succinic acid, malinic acid, lactic acid, butyric acid and tartaric acid.

3. The method for cooking at least one of a raw meat and a raw marine product according to claim 1, wherein the providing the oil component includes providing at least one of edible fat and oil.

4. The method for cooking at least one of a raw meat and a raw marine product according to claim 1, wherein the providing the oil component includes providing a first oil component and a second oil component.

5. The method for cooking at least one of a raw meat and a raw marine product according to claim 1, wherein the providing the oil component includes providing a liquid oil component and a solid oil component at room temperature.

6. The method according to claim 1, wherein the providing the oil component includes providing an amount of the oil component substantially equal to at least 50% by mass of the paste.

7. The method for cooking at least one of a raw meat and a raw marine product according to claim 1, wherein the providing further includes providing a sugar, and the combining further includes combining the sugar.

8. The method for cooking at least one of a raw meat and a raw marine product according to claim 7, further comprising cooling the at least one of the raw meat and the raw marine product with the paste thereon before the microwave cooking.

9. The method for cooking at least one of a raw meat and a raw marine product according to claim 7, further comprising freezing the at least one of the raw meat and the raw marine product with the paste thereon before microwave cooking.

10. The method for cooking at least one of a raw meat and a raw marine product according to claim 8, further comprising freezing the at least one of the raw meat and the raw marine product with the paste thereon after the cooling and before the microwave cooking.

11. The method for cooking at least one of a raw meat and a raw marine product according to claim 10, wherein the microwave cooking further includes microwave cooking the at least one of the frozen raw meat and the frozen raw marine product with the paste thereon.

12. The method for cooking at least one of a raw meat and a raw marine product according to claim 7, further comprising enwrapping the at least one of the raw meat and the raw marine product with the paste thereon in a sheet before microwave cooking.

13. The method for cooking at least one of a raw meat and a raw marine product according to claim 12, further comprising expelling the air from the bag after enwrapping and before microwave cooking.

14. The method for cooking at least one of a raw meat and a raw marine product according to claim 12, further comprising cooling the at least one of the raw meat and the raw marine product with the paste thereon before the microwave cooking.

15. The method for cooking at least one of a raw meat and a raw marine product according to claim 12, further comprising freezing the at least one of the raw meat and the raw marine product with the paste thereon before the microwave cooking.

16. The method for cooking at least one of a raw meat and a raw marine product according to claim 14, further comprising freezing the at least one of the raw meat and the raw marine product with the paste thereon after the cooling and before the microwave cooking.

17. The method for cooking at least one of a raw meat and a raw marine product according to claim 15, wherein the microwave cooking further includes microwave cooking the at least one of the frozen raw meat and the frozen raw marine product with the paste thereon.

18. The method for cooking at least one of a raw meat and a raw marine product according to claim 1, wherein the providing further includes providing water, the forming a paste further includes forming a paste from the water, and the combining further includes combining the water into the mixture.
